(19) United States
(12) Patent Application Publication
(10) Pub. No.: US 2023/0172307 A1
(43) Pub. Date: Jun. 8, 2023

(54) WEARABLE POWER GENERATION AND CHARGING DEVICE

(71) Applicant: Capped Out Media, Taylorsville, UT (US)

(72) Inventor: Waynard Schmidt, Taylorsville, UT (US)

(73) Assignee: Capped Out Media, Taylorsville, UT (US)

(21) Appl. No.: 17/545,884

(22) Filed: Dec. 8, 2021

(51) Int. Cl. A43B 3/42; A43B 3/40; H02J 50/10; H02J 50/80; H02N 2/18; H02J 7/00

(52) U.S. Cl. CPC A43B 3/42; A43B 3/40; H02J 50/10; H02J 50/80; H02N 2/181; H02J 7/0029; H02J 7/00036; H02J 7/0042; H02J 7/007

(57) ABSTRACT

A wearable charging device may include a shoe. The shoe may include an outsole, an insole, and a sole compartment. The sole compartment may be defined by a void between a bottom surface of the insole, a top surface of the outsole, and an inside surface of a midsole disposed perpendicular to the top surface of the outsole and extending along a perimeter of the outsole and insole. The device may further include a power source, and a wireless charging interface. The wireless charging interface may include a wireless charging transmitter coil abutted to the top surface of the outsole and may be in electrical communication with the power source. The wearable charging device may further include at least one electric generator in electrical communication with the power source. The electric generator may convert mechanical energy into electrical energy.

### FIELD OF INVENTION

The present invention is in the field of power delivery devices. Specifically, portable charging devices that can be worn by their user.

### INTRODUCTION

In current time, one of the most important features of any portable device is its power source. Since portable devices, such as cell phones and smart watches, entered mainstream use, it has been a focus of consumers to purchase a device that has enough electrical capacity to power the device throughout the day. Unfortunately, however, many devices run out of power before the user has a chance to charge the battery. This can be for multiple reasons, such as excessive use of the device, that increase power usage of the device, or old age of the power source which decreases its capacity.

To address this concern, a user may choose to carry around an external battery. But this can be cumbersome and take up valuable bag or pocket space. Moreover, the user eventually must recharge the external battery once its capacity has been depleted, which can be an inconvenience. An even greater inconvenience occurs when the user forgets to recharge their external battery when their device runs out of power, at which point the user will likely need to sit by an electrical outlet and wait until their device and/or external battery is charged. Moreover, many external-charging devices require the user to use long tangle-prone cables or bulky connectors.

Accordingly, it would be desirable to have a charging device that does not take up valuable storage space on its user and has a battery that charges on the go without having to be connected to an electrical outlet. It would be further desirable to have a charging device that enables wireless charging. It would be yet further desirable to provide a charging device that permits a user to charge a rechargeable device while the device is in a convenient location, for example, a pant pocket.

### SUMMARY

In an aspect of this disclosure, a wearable charging device may include a shoe. The shoe may include an outsole, an insole, and a sole compartment. The sole compartment may be defined by a void between a bottom surface of the insole, a top surface of the outsole, and an inside surface of a midsole disposed perpendicular to the top surface of the outsole and extending along a perimeter of the outsole and insole. The device may further include a power source, and a wireless charging interface. The wireless charging interface may include a wireless charging transmitter coil abutted to the top surface of the outsole and may be in electrical communication with the power source. The wearable charging device may further include at least one electric generator in electrical communication with the power source. The electric generator may convert mechanical energy into electrical energy.

In an embodiment, the electric generator may be a piezo electric crystal.

In another embodiment, the electric generator may include a wire coil, and a magnet. The magnet may be disposed at an approximate center point of a diameter of the wire coil. The magnet may be attached to the bottom surface of the insole and may be configured to move freely through the wire coil so as to produce an electrical current in the wire coil.

In another embodiment, the power source may be a battery. In an embodiment, the battery may be a lithium-ion battery. In yet another embodiment, the lithium-ion battery may be an 18650 lithium-ion battery with a power density of 3400 mAh.

In another embodiment, the wearable charging device may further include a USB charging interface, wherein the USB charging interface may intersect the inside surface and an outer surface of the midsole, and wherein the USB charging interface may be electrically connected to the power source.

In an embodiment, the insole may further include an EMF blocking material adhered to a total surface area of at least one of a top surface of the insole or the bottom surface of the insole.

In yet another embodiment, the EMF blocking material may be a flexible electromagnetic interference shielding film.

In another embodiment, the EMF blocking material may be a copper-nickel composition fabric.

The invention of the present disclosure may further comprise an outgoing transmitter coil, and an outgoing transmitter wire in electrical communication with at least the outgoing transmitter coil and the power source. In an embodiment, the device may further comprise a secondary apparel receiver configured to receive energy from the outgoing transmitter coil, a secondary apparel wire, and a secondary apparel transmitter, wherein the secondary apparel wire is in electrical communication with at least the secondary apparel receiver and the secondary apparel transmitter, and wherein the secondary apparel transmitter is configured to transmit energy to a rechargeable device.

In a further embodiment, the secondary apparel receiver, the secondary apparel wire, and the secondary apparel transmitter are disposed within a secondary apparel.

In an embodiment, the secondary apparel is a pair of pants, wherein the secondary apparel receiver is disposed on a bottom portion of the pair of pants, wherein the secondary apparel wire traverses the bottom portion of the pair of pants and a pocket, and wherein the secondary apparel transmitter is disposed in a proximity to the pocket. The invention of the present disclosure may further comprise a joining mechanism configured to hold the secondary apparel receiver a sufficient distance from the outgoing transmitter coil.

Additional aspects related to this disclosure are set forth, in part, in the description which follows, and, in part, will be obvious from the description, or may be learned by practice of this disclosure.

It is to be understood that both the forgoing and the following descriptions are exemplary and explanatory only and are not intended to limit the claimed disclosure or application thereof in any manner whatsoever.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 shows a cutaway side view of a wearable charging device.

FIG. 2 is an illustration of an embodiment of a wearable charging device.

FIGS. 3A-3B are illustrations of an embodiment of a wearable charging device comprising a charging extension to a secondary apparel.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

Circuit elements and diagrams disclosed herein are simplified to articulate the key features of the present disclosure, and such elements and diagrams are sufficient to enable those skilled in the art to practice the disclosure.

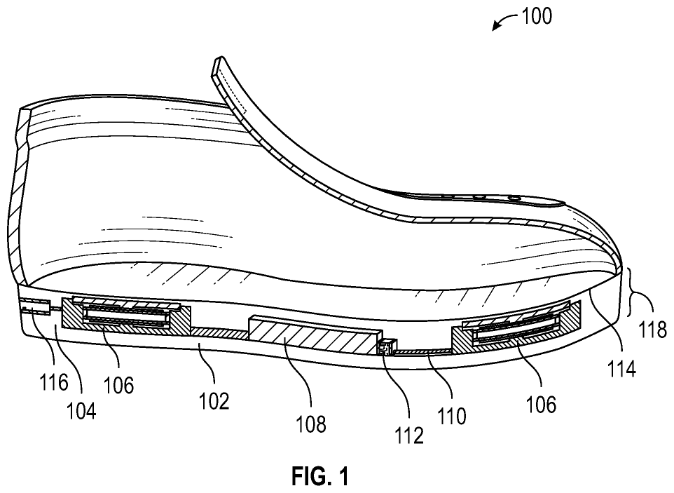

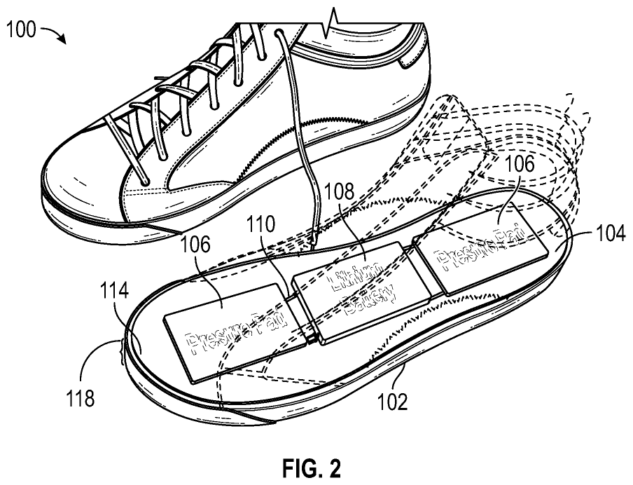

Referring to FIGS. 1-2, in an embodiment the disclosed device includes a shoe 100. The shoe 100 may be a boot, a sneaker, a loafer, a slipper, or any other apparel worn on a person's foot. The shoe 100 may be a variety of sizes. As a non-limiting example, the shoe 100 size may range from US size 4-12 for women, and US size 6-16 for men. The shoe 100 size may also be any size appropriate for being worn on a person's foot. In an alternate embodiment, the electrical components comprising the invention may be retrofitted for any preexisting shoe.

The shoe 100 may include an outsole 102. The outsole 102 may traditionally be located on, and covering, a bottom side of the shoe 100. However, in an embodiment, the outsole 102 may only cover a portion of the bottom side of the shoe 100. The outsole 102 may be made from a durable material such as rubber, leather, or Ethylene-Vinyl Acetate (“EVA”) foam. Types of rubber may include carbon rubber, blown rubber, or any suitable rubber known to those skilled in the art. The outsole 102 may be a variety of thicknesses. Such a thickness of the outsole 102 may not exceed 40 mm to allow for wireless charging through the material. In an embodiment, the thickness of the outsole 102 fluctuates at different points. As a non-limiting example, the thickness of the outsole 102 may be 10 mm, except for the area where a wireless charging transmitter coil 110 is abutted to a topside of the outsole 102 within the sole compartment 104, where the outsole 102 thickness may be 5 mm. The thickness of the outsole may be any suitable thickness known to those skilled in the art.

In an embodiment, the shoe 100 also includes an insole 114. The insole 114 may be disposed inside of the shoe 100 between a user's foot, and the outsole 102 when worn. The insole 114 may be made from a variety of materials comfortable for the user when worn against their foot. The insole 114 may be made from materials such as foam, gel, cork, or leather. In an embodiment, the insole may include a material known to block electromagnetic frequencies (“EMFs”) such as a flexible electromagnetic interference shielding film, or copper-nickel composition fabric. In another embodiment, the EMF blocking material may only cover an area located directly above a wireless charging coil 110. The wireless charging coil 110 is discussed in further detail below.

The shoe 100 may also include a sole compartment 104 located between the insole 114 and the outsole 102. The sole compartment 104 may extend from a rearmost portion of the shoe 100, to a frontmost portion of the shoe 100. In other embodiments, the shoe compartment 104 may be any size suitable for fitting components 106-112. Accordingly, the sole compartment 104 may be a cavity bound by the insole 114, the outsole 102, and the perimeter walls of the shoe 100. In an embodiment, the sole compartment 104 may be accessed by removal of the insole 114. Further, a rigid layer may be disposed between the insole 114 and the shoe compartment 104 (for example, to prevent a user's foot from negatively physically interfering with the contents of the shoe compartment 104). Such a rigid layer may include one or more windows configured to allow the user's foot to move the at least one electrical generator 106. Further, the rigid layer may include one or more windows (or portions of decreased thickness) disposed in proximity to the coil 110. In another embodiment, a rigid layer may be disposed above and/or below the sole compartment 104.

The sole compartment 104 may contain at least one electrical generator 106. As a non-limiting example, the sole compartment 104 may contain two electrical generators. In such an example, one electrical generator 106 is positioned within the sole compartment 104 at an approximate point underneath a heel of the foot of the user when the shoe 100 is worn, and a second electrical generator 106 is positioned within the sole compartment 104 at an approximate point underneath a ball of the foot of the user when the shoe 100 is worn. However, there may be any suitable number of electrical generators 106 contained within the sole compartment 104. The electrical generator(s) 106 may be a piezoelectric generator or a magnet and coil generator. Alternatively, the electrical generator(s) 106 may be any generator that converts mechanical energy into electrical energy. In an embodiment in which the electrical generator(s) 106 is a magnet and coil generator, the magnet is adhered to an underside of the insole 114 such that movement produced by a user causes the magnet to move through an approximate center of the coil of wire, which in turn produces a current. In another embodiment in which the electrical generator is a piezoelectric generator, a user generates a current as their foot applies pressure to the piezoelectric generator as the user moves. As a non-limiting example, movement may be generated by walking, running, and/or jumping. In an embodiment, the electrical generator 106 may generate electricity upon depression and release of the electrical generator 106. Current produced by the electric generator(s) 106 may then be used to charge a power source 108, which is discussed further below.

In an embodiment, the sole compartment 104 may also contain at least one power source 108. The power source 108 may be a rechargeable battery (for example, a 26800 mAh battery). In such an embodiment the battery may be any one of lithium-ion, lithium-metal, magnesium ion, lithium iron (for example, a lithium iron phosphate battery), or nickel-cadmium. In a further embodiment, the battery is an 18650 lithium-ion battery. Alternatively, the battery may be any suitable type of rechargeable battery known to those skilled in the art. The disclosed device may contain a series of batteries. Each battery may have a power-density between 2500 and 3500 mAh. However, batteries of different power-densities may be used. In an embodiment, the shoe 100 may include a battery door configured to enable removal of the rechargeable battery. In such an embodiment, a battery door disposed on the outsole 102 (or other component of the shoe 100) may allow fluid communication between the sole compartment 104 and the environment. The battery door may “snap” into place, such that during walking and/or running, the battery door remains firmly shut.

The disclosed device may contain at least one wireless charging transmitter coil 110 and a controller 112. In an embodiment, the controller 112 is operably coupled to the wireless charging transmitter coil 110. The wireless charging transmitter coil 110 may be abutted to a topside of the outsole 102 within the sole compartment 104. However, the controller 112 may be positioned anywhere within the sole compartment 104. In an alternate embodiment, there may be at least two wireless charging transmitter coils 110. In such an embodiment, each coil may be positioned at different locations within the sole compartment 104, or the coils may be positioned adjacent to each other to provide a greater charging area. In an embodiment, the transmitter coil 110 may be disposed on the inside surface of the toebox, the eyestays, laces, or tongue. Accordingly, the transmitter coil 110 may be disposed under any potion of the shoe 100 where a user may conveniently position a rechargeable device. Such shoe 100 portions (for example, the toebox, the eyestays, and/or tongue) may be sufficiently thin to enable wireless charging. As a non-limiting example, the toebox, eyestays, toungue, side wall, etc., may be 40 mm or less in thickness to enable sufficient wireless charging. Further, any of the aforementioned components may be less than 10 mm, 5 mm, or 3 mm in thickness to promote more efficient wireless charging. In another embodiment, the sidewalls of the shoe 100 may contain the transmitter coil 100, enabling wireless charging through the side wall. The transmitter coil 110 may also be disposed within the sidewall of the sole, for example a sidewall of the midsole 118.

As a non-limiting working example, when a user places a wireless charging receiver coil (not shown) within close proximity of the wireless charging transmitter coil 110, a wireless energy transfer initiates, charging the user rechargeable device. As a further non-limiting example, such proximity may be achieved by abutting the wireless charging receiver coil (not shown) against the underside of the outsole 102 of the shoe 100, at the same approximate position of the wireless charging transmitter coil 110. The wireless charging transmitter coil 110 may be configured to have an output between 5 and 10 watts. Further, the wireless charging transmitter coil 110 may operate at or around 5 Volts. However, the wireless charging transmitter coil 110 may be configured to output at any sufficient value to initiate wireless charging. In an embodiment, the wireless charging transmitter coil 110 may be disposed on the underside of the insole 114, such that a wireless charging receiver coil (not shown) may be placed upon the toe vamp or toe cap to initiate charging. In a further embodiment, the toe vamp or toe cap of the shoe 100 may include a niche or dock configured to accept and hold the user rechargeable device. Accordingly, the shoe 100 may include a niche, dock, or pocket, enabling wireless charging of a rechargeable device while the user is walking. For example, the niche, dock, or pocket may hold the rechargeable device tightly and/or may include a strap, buckle, or other fastener configured to hold the rechargeable device securely during active use (for example, walking or jogging).

The device may include a charging port 116 to provide a faster charging option. The charging port 116 may be a universal serial bus (“USB”) interface. However, the charging port 116 may be any suitable style of charging interface. The charging port 116 may be disposed through a midsole 118 of the shoe 100. In an embodiment, the charging port 116 may further include a cover (not shown). The cover may be made from water-resistant materials such as rubber or polyethylene to keep out water and dust. Alternatively, the cover may be constructed by any water-resistant material known to those skilled in the art. The charging port 116 may be in electrical communication with at least the power source 108. In one embodiment, the charging port 116 may interface directly with the user rechargeable device. In another embodiment, the charging port 116 may interface indirectly with the user rechargeable device (for example, via a charging cable). In an embodiment, the charging port 116 includes a retractable charging cable. In such an embodiment, the charging cable may be stored within the sole compartment 104 during a passive state (for example, when not charging) and may be extracted from the sole compartment 104 during an active state (for example, when charging).

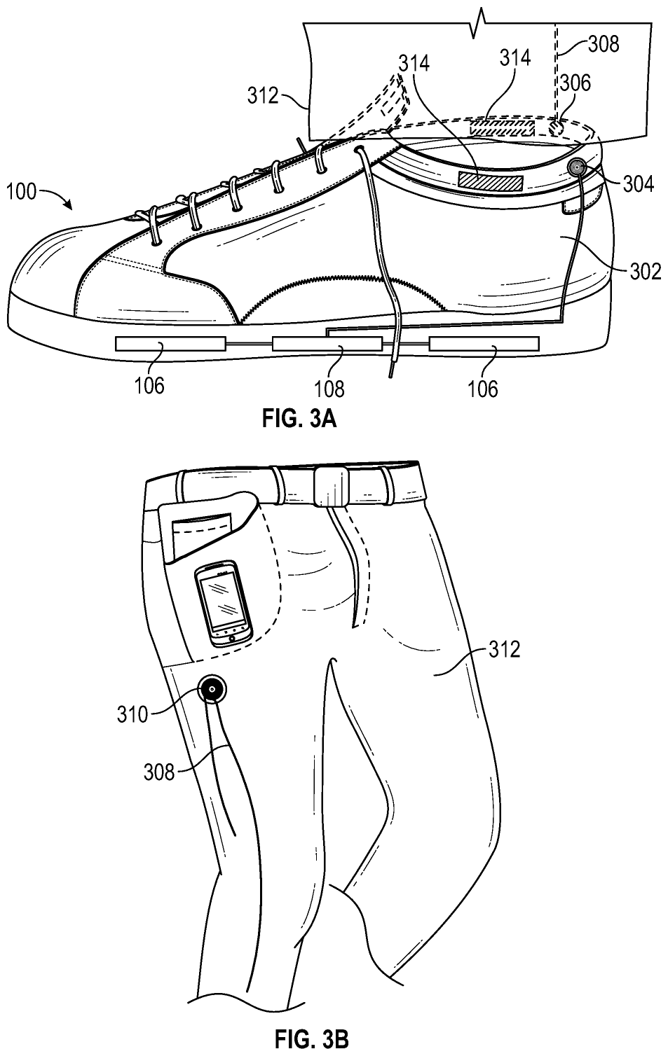

Referring to FIG. 3A, the shoe 100 may further comprise an outgoing transmitter coil 304 in electrical communication with the power source 108 (for example, via an outgoing transmitter wire 302). In an embodiment, the outgoing transmitter wire 302 is attached to the power source 108 and is sewn into the inside of the shoe 100, such that the outgoing transmitter coil 304 may reside within the top portion of the shoe 100. The shoe 100 may be in physical contact with pants 312. The pants 312 may include a pant leg, where the bottom of the pant leg rests upon the top portion of the shoe 100. The pants 312 may include a secondary apparel receiver 306 and a secondary apparel wire 308. The secondary apparel receiver 306 is configured to receive energy from the outgoing transmitter coil 304 (for example, in a manner similar to that between the wireless charging transmitter coil 110 and the rechargeable device). The outgoing transmitter coil 304 and the secondary apparel receiver 306 may be configured to interface at the meeting point of the pant leg and the top portion of the shoe 100. In such an embodiment, the outgoing transmitter coil 304 and the secondary apparel receiver 306 may be positioned in their respective apparel, such that the outgoing transmitter coil 304 and the secondary apparel receiver 306 are within 40 mm proximity. However, the outgoing transmitter coil 304 and the secondary apparel receiver 306 may enable charging at any suitable distance.

In an embodiment, the shoe 100 may include solely a transmitter coil 110, wherein the transmitter coil 110 functions in accordance with this disclosure's description of the outgoing transmitter coil 304. Thus, the shoe 100 may include a transmitter coil 110, a transmitter coil 110 and an outgoing transmitter coil 304, or an outgoing transmitter coil 304. Accordingly, the invention of the present disclosure may be configured to charge a rechargeable device via contact to the shoe 100 and/or pants pocket.

In a further embodiment, the shoe 100 and the pants 312 include a joining mechanism 314. The joining mechanism 314 may be configured to maintain the pants 312 in close proximity to the shoe 100. For example, the joining mechanism 314 may retain the bottom of the pant leg over the top portion of the shoe, such that the secondary apparel receiver 306 and the outgoing transmitter coil 304 may adequately exchange energy. In one embodiment, the joining mechanism 314 may include a first magnet disposed within the pants 312 and a second magnet disposed within the shoe 100, such that the magnets attract, maintaining the outgoing transmitter coil 304 and secondary apparel receiver 306 in close proximity. In various embodiments, close proximity may be any distance enabling sufficient wireless charging or may be any distance under 40mm. In another embodiment, the joining mechanism 314 may be one or more fasteners disposed on the shoe 100 and/or the pants 312. For example, a first portion of hook and loop fastener may be disposed on the shoe 100 and a second portion of hook and loop fastener may be disposed on the pants 312, such that the hook and loop adheres, causing the secondary apparel receiver 306 and outgoing transmitter coil 304 to situate within adequate charging proximity.

In an alternate embodiment, a secondary apparel battery may be stored in the lower portion of the pant leg. Accordingly, the outgoing transmitter coil 304 may charge the secondary apparel battery. In such an embodiment, the secondary apparel wire 308 may transmit power from the secondary apparel battery to the secondary transmitter coil 310, where the secondary transmitter coil 310 may then charge a rechargeable device.

In another embodiment, the outgoing transmitter wire 302 connects the power source 108 to a connector, wherein the connector is any suitable hardwired shoe connector configured to transmit electricity. In such an embodiment, the pants 312 include a hardwired pants connector configured to receive electricity. Accordingly, a hardwired connection may be established between the hardwired shoe connector and the hardwired pants connector by physically attaching the two connectors. The hardwired connectors may be any suitable male and/or female power adapters, for example, 5.5×2.5 mm, 5.5×2.1 mm, 4.8×1.7 mm, micro USB, USB, 4.0×1.7 mm, 3.5×1.35 mm, 3.0×1.1 mm, and/or 2.35×0.75 mm. In such an embodiment, a power cable may initiate energy transfer, as opposed to wireless energy transfer.

The shoe 100 may include a pocket, niche, or cavity, sized to accept the hardwired shoe connector (for example, in a retracted state). Similarly, the pants 312 may include a stitching and/or pocket sized to hold and conceal (for example, in a retracted state) the hardwired pants connector.

Referring to FIG. 3B, the pants 312 may include a secondary transmitter coil 310. The secondary transmitter coil 310 may be attached to the secondary apparel wire 308, where the secondary apparel wire 308 may be sewn into the inside surface of the pants 312. Accordingly, the secondary transmitter coil 310 may be in indirect electrical communication with the power source 108. In an embodiment, the secondary transmitter coil 310 is stitched into the inside surface of the pants 312 in close proximity to a pocket. For example, the secondary transmitter coil 310 is disposed around a pocket, where a user may deposit a rechargeable device within the pocket, enabling wireless charging of the device.

In another embodiment, a hardwired electrical communication is formed between the secondary apparel wire 308 and the rechargeable device. In such an embodiment, a hardwired electrical output may be disposed at the pocket end of the secondary apparel wire 308. For example, the electrical output may be a USB connector, enabling a user to attach a USB-connectable rechargeable device. However, the electrical output may be any suitable connection format. The electrical output may be thread through the lining of the pocket, such that the electrical output is accessible from within the pocket.

In yet another embodiment, the pocket may include a rechargeable device dock. The rechargeable device dock may be any attachment mechanism configured to maintain the position of the rechargeable device within the pocket. For example, the attachment mechanism may be an elastic band or secondary nested pocket. The attachment mechanism may be configured to maintain the rechargeable device in consistent close proximity to the secondary transmitter coil 310. In an embodiment, the pocket may be affixed to the pants 312, such that the rechargeable device maintains close proximity to the secondary transmitter coil 310. For example, a member similar to the joining mechanism 314 may be disposed between the pocket, the rechargeable device, and/or the pants 312.

The secondary apparel wire 308 may be an antenna configured to run alongside the leg to allow charging in the pocket. In an embodiment, pants, having the antenna, rest upon the shoe, forming a “wireless contact” between the shoe and the pants and a second “wireless contact” between the pants and the rechargeable device.

The pants 312 may include an antenna or secondary apparel wire 308 in the seam of the pants 312, which runs up the leg vertically. As the shoe 100 touches the seam of the pants it may make a “wireless” connection. The antenna may transmit energy up the pant leg, to the pocket, which allows the user to charge a mobile phone in their pocket. In an embodiment, the antenna (secondary apparel wire 308) is only “active” when it is in close proximity to the shoe 100. Accordingly, the pants may be machine washable.

In an embodiment, the components within the pants 312 are retrofittable for any suitable pair of pants. Effectively, the secondary apparel receiver 306, the secondary apparel wire 308, and the secondary apparel transceiver coil 310 may be added to any preexisting pair of pants. The secondary apparel receiver 306, the secondary apparel wire 308, and/or the secondary apparel transceiver coil 310 may be sewn into the inside surface of the pants 312 in a concealable manner. For example, the secondary apparel wire 308 may be disposed behind or within the longitudinal side stitch of any standard pant leg. As another non-limiting example, the secondary apparel receiver 306 may be disposed behind or within a cuff and/or a stitch disposed on the bottom opening of any standard pant leg.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A wearable charging device, comprising:
a shoe, including:
an outsole;
an insole; and
a sole compartment, defined by a void between a bottom surface of the insole, a top surface of the outsole, and an inside surface of a midsole disposed perpendicular to the top surface of the outsole and extending along a perimeter of the outsole and insole;
a power source;
a wireless charging interface, including;
a wireless charging transmitter coil, abutted to the top surface of the outsole and in electrical communication with the power source;
at least one electric generator in electrical communication with the power source;
wherein the electric generator converts mechanical energy into electrical energy.

2. The wearable charging device of claim 1, wherein the electric generator is a piezo electric crystal.

3. The wearable charging device of claim 1, wherein the electric generator includes:
a wire coil; and
a magnet, disposed at an approximate center point of a diameter of the wire coil;
wherein the magnet is attached to the bottom surface of the insole and is configured to move freely through the wire coil so as to produce an electrical current in the wire coil.

4. The wearable charging device of claim 1, wherein the power source is a battery.

5. The wearable charging device of claim 4, wherein the battery is a lithium-iron battery.

6. The wearable charging device of claim 5, wherein the lithium-iron battery is an 18650 lithium-ion battery with a power density of 3400 mAh.

7. The wearable charging device of claim 1, further including a USB charging interface, wherein the USB charging interface intersects the inside surface and an outer surface of the midsole, and wherein the USB charging interface is electrically connected to the power source.

8. The wearable charging device of claim 1, wherein the insole further includes an EMF blocking material adhered to a total surface area of at least one of a top surface of the insole or the bottom surface of the insole.

9. The wearable charging device of claim 8, wherein the EMF blocking material is a flexible electromagnetic interference shielding film.

10. The wearable charging device of claim 8, wherein the EMF blocking material is a copper-nickel composition fabric.

11. The wearable charging device of claim 1, further comprising:
an outgoing transmitter coil; and
an outgoing transmitter wire in electrical communication with at least the outgoing transmitter coil and the power source.

12. The wearable charging device of claim 11, further comprising:
a secondary apparel receiver configured to receive energy from the outgoing transmitter coil;
a secondary apparel wire; and
a secondary apparel transmitter,
wherein the secondary apparel wire is in electrical communication with at least the secondary apparel receiver and the secondary apparel transmitter, and
wherein the secondary apparel transmitter is configured to transmit energy to a rechargeable device.

13. The wearable charging device of claim 12, wherein the secondary apparel receiver, the secondary apparel wire, and the secondary apparel transmitter are disposed within a secondary apparel.

14. The wearable charging device of claim 13, wherein the secondary apparel is a pair of pants, wherein the secondary apparel receiver is disposed on a bottom portion of the pair of pants, wherein the secondary apparel wire traverses the bottom portion of the pair of pants and a pocket, and wherein the secondary apparel transmitter is disposed in a close proximity to the pocket.

15. The wearable charging device of claim 14, further comprising a joining mechanism configured to hold the secondary apparel receiver a sufficient distance from the outgoing transmitter coil.

16. The wearable charging device of claim 15, wherein the close proximity and the sufficient distance are less than 40 mm.
